(19) United States
(12) Patent Application Publication
(10) Pub. No.: US 2008/0238190 A1
(43) Pub. Date: Oct. 2, 2008

(54) Separable Rubber Track of Tank

(76) Inventors: Tae sung Kim, Gyeonggi-do (KR); Yong hee Won, Seoul (KR)

Correspondence Address: COOPER & DUNHAM, LLP, 1185 AVENUE OF THE AMERICAS, NEW YORK, NY, 10036, US

(21) Appl. No.: 10/593,003

(22) PCT Filed: Mar. 18, 2005
(86) PCT No.: PCT/KR2005/000783

§ 371 Date: Sep. 14, 2006

(30) Foreign Application Priority Data
Mar. 19, 2004 (KR) 10-2004-0018936

(51) Int. Cl. B62D 55/215

(52) U.S. Cl. 305/41

(57) ABSTRACT

The present invention relates to a separable rubber track used in a tank. The rubber track is divided into a plurality of track units. A pair of connection cores connected to steel cores is provided on both ends of the track unit. The track units are connected to each other through coupling members rotatably combined with the connection cores to form an integrated endless track. Therefore, when a part of rubber molding is damaged during operation, it is possible to easily replace the damaged part with a new one. Therefore, it is possible to remarkably reduce the time and expenses spent on maintaining and repairing the rubber track, to prolong the life of the rubber track, and to conveniently replace the damaged part on site.

The present invention relates to a separable rubber track used in a tank, and more particularly to a separable rubber track of a tank in which, when a part of rubber molding is damaged when traveling, only the damaged part need be replaced such that it is possible to significantly reduce the time and expense needed for maintenance and repair, to prolong the life of the rubber track, and to easily replace the damaged part with a new one on site.

### BACKGROUND OF THE INVENTION

In general, the operation and maintenance of military equipment are significantly important such that the mobility of the military equipment can be maximized.

In particular, it is important to maintain and manage the tracks of a tank since they directly affect mobility.

Also, since the tank travels on paved roads as well as unpaved roads, rubber tracks in which steel cores are molded by rubber are widely used in order to protect the road, to reduce vibration and noise generated when in motion, and to dampen the load applied to the pins.

FIGS. 1 and 2 are a side view and a sectional view illustrating an example of such rubber tracks. Referring to FIGS. 1 and 2, each rubber track 20 includes steel cores 2 engaged with sprockets 21, wheel side pads 5 molded of rubber so as to contact driving wheels 23 inside the steel cores 2, and bottom pads 7 molded of rubber so as to prevent road damage and to reduce vibration and noise outside the steel cores 2.

In other words, the rubber track 20 is constructed such that a plurality of steel cores 2 is integrated by being molded of rubber. A plurality of folds of fiber (not shown) is built in the rubber molding such that the strength of the fiber reinforces the molded rubber.

However, when the tank travels with such a rubber track mounted in the tank, a soft part of the rubber molding is easily damaged. In such a case, since the track is integrated by rubber molding, the entire track must be replaced. Therefore, the life of the track is significantly reduced, which is uneconomical.

Furthermore, since the replacement of the track cannot be performed on the spot, the tank must be transported to a repair and maintenance place to repair the tank. Therefore, added expense and time are spent maintaining and repairing the tank.

### SUMMARY OF THE INVENTION

Therefore, the present invention has been made in view of the above problems, and it is an object of the present invention to provide a separable rubber track of a tank in which, when a part of the rubber molding is damaged when traveling, only the damaged part need be replaced such that it is possible to significantly reduce time and expense spent on maintenance and repair, to prolong the life of the track, and to easily replace the damaged part with a new one on the spot. Therefore, it is possible to improve the mobility of the tank.

In accordance with an aspect of the present invention, the above and other objects can be accomplished by the provision of a separable rubber track of a tank molded such that a plurality of steel cores engaged with a sprocket are integrated with each other by rubber, the rubber track including the rubber track divided into a plurality of track units, each track unit having a pair of connection cores connected to the steel cores and provided on both ends of the track unit, and coupling members rotatably coupled with the connection cores such that the track units are connected to each other by coupling members to form an integrated continuous track.

Therefore, since the rubber track is divided into a plurality of track units, when a part of the track is damaged when traveling, it is possible to replace the damaged track unit with a new track unit simply by unfastening the bolt fastened in a fastening piece, that is, the replacement of the rubber track can be easily performed on site. Therefore, it is possible to significantly reduce the time and effort spent on maintaining and repairing the tank and to maximize the mobility of the tank.

### DESCRIPTION OF THE DRAWINGS

The above and other objects, features and other advantages of the present invention will be more clearly understood from the following detailed description taken in conjunction with the accompanying drawings, in which:

FIG. 1 is a side view of a tank in which a conventional integrated rubber track is installed;

FIG. 2 is a sectional view of the conventional rubber track;

FIG. 3 is a perspective view of a separable rubber track of a tank according to a preferred embodiment of the present invention; and

FIG. 4 is a perspective view of the main parts of the separable rubber track of a tank in FIG. 3.

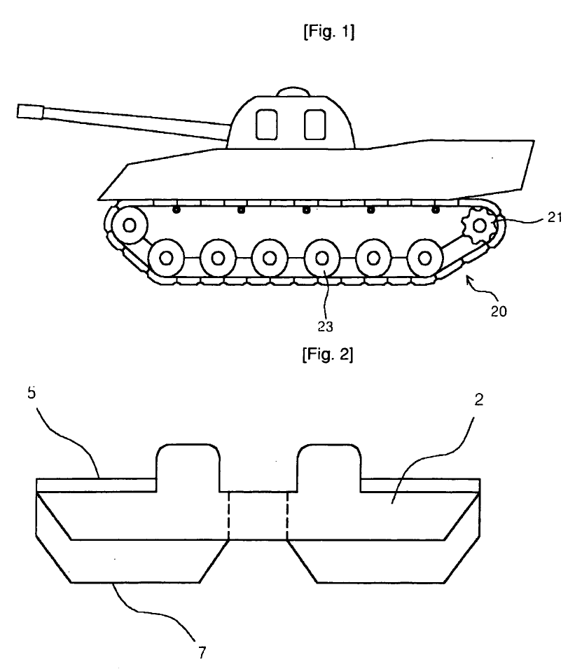

### EMBODIMENTS OF THE INVENTION

The preferred embodiments of the present invention will be described in detail with reference to accompanying drawings such that those skilled in the art may fully understand the concept of the present invention. However, various changes in form and detail may be made without departing from the spirit and scope of the invention.

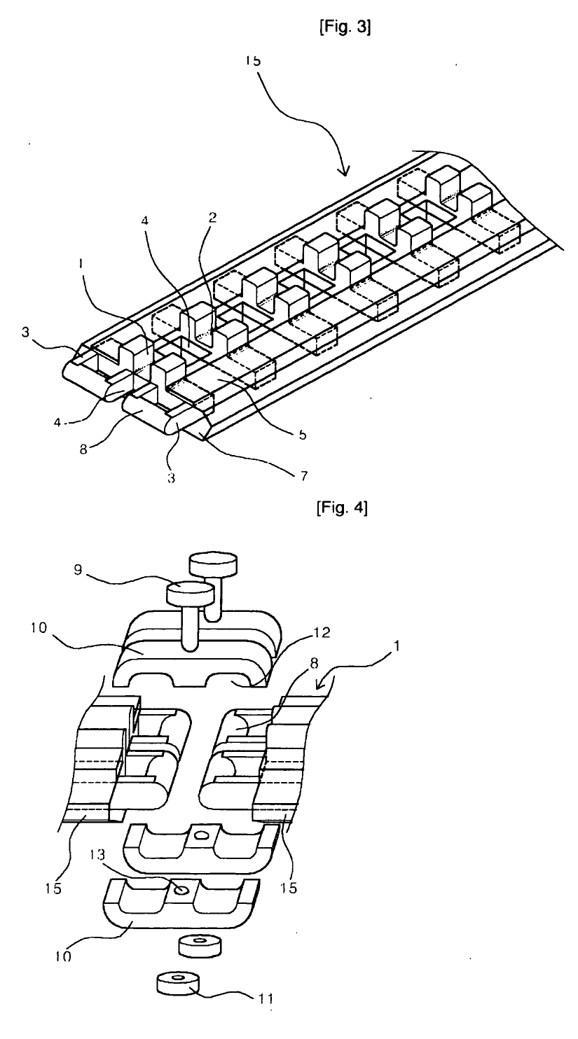

FIG. 3 is a perspective view of a separable rubber track of a tank according to the preferred embodiment of the present invention, and FIG. 4 is a perspective view of the main parts of the separable rubber track of a tank in FIG. 3.

As shown in FIGS. 3 and 4, the separable rubber track of a tank according to the preferred embodiment of the present invention is constructed such that plural steel cores 2, engaged with a sprocket (not shown), are integrated by being molded of rubber. The rubber track is divided into a plurality of track units 15. A pair of connection cores 1 connected to a steel core 2 are included on both ends of each track unit 15 such that the track units 15 are connected to each other through coupling members 10 rotatably coupled with the connection cores 1 to form an integrated endless track.

The separable rubber track is characterized in that a single track is divided into a plurality of track units 15. Each track unit 15 includes a pair of connection cores 1 connected to a steel core 2 on both ends thereof such that the respective track units 15 are connected to each other through coupling members 10 rotatably coupled with the connection cores 1.

Each track unit 15 is formed by dividing a single rubber track into multiple rubber tracks. In the track unit 15, a plurality of steel cores 2 engaged with the sprocket is arranged at regular intervals, rubber wheel side pads 5 that contact the driving wheels of the tank are molded inside the steel cores 2, and a rubber bottom pad 7 is molded outside the steel cores 2.

Several layers of fibers and iron cores are inserted into each rubber molding such that the strength of the rubber is reinforced.

The connection cores 1 aligned with the steel cores 2 protrude by predetermined length from both ends of each track unit 15 such that the respective track units 15 are connected to each other through the connection cores 1.

The track unit 15 is constructed from at least six rubber tracks such that it is possible to replace only the damaged rubber track with a new rubber track. Therefore, expenses can be reduced and the replacement of the damaged rubber track can be more easily performed.

In the present embodiment, the rubber track of a tank is constructed of track units 15 formed by dividing the rubber track into eight rubber tracks.

The connection cores 1 have a similar structure to that of the steel cores 2, include two pairs of brackets 3 protruded from both leading ends of the connection core 1, and connection pins 8, formed in the leading ends of the brackets 3, for coupling the coupling members 10, to be described later, with the leading ends of each pair of brackets 3.

The connection pins 8 may be separate pins penetrating the brackets 3, or may be integrally formed with each pair of the brackets 3.

Also, a hole 4 with which the sprocket is engaged is formed between the two pairs of brackets 3 in the same fashion as the steel core 2.

The coupling members 10 couple respective track units 15 with each other to form a complete track. Each coupling member 10 is divided into two such that top and bottom parts of the coupling member 10 are symmetrical with each other and are coupled with each other by fastening bolts 9.

As described above, a bolt combination hole 13 penetrates the coupling member 10 in the middle of the coupling member 10 divided into top and bottom parts. Connection grooves 12 for surrounding the connection pins 8 to rotate within the connection grooves 12 are formed on both ends on the surfaces that face each other of the coupling members 10, such that adjacent track units 15 are connected to each other.

The operation of the rubber track of a tank according to the preferred embodiment having the above-described structure will be described as follows.

The separable rubber track is divided into the plurality of track units 15 such that the respective track units 15 are connected to each other via the coupling members 10, thus forming a single complete rubber track.

In other words, since the connection cores 1 including the connection pins 8 in the leading ends thereof are aligned with the steel cores 2 on both ends of the track units 15 and protrude by predetermined length, the connection grooves 12 of the coupling members 10 divided into top and bottom parts are aligned with the connection pins 8 such that the pair of top and bottom combination members 10 are fastened to each other by the bolts 9 to rotatably connect adjacent track units 15.

Connecting the plurality of divisional track units 15 to each other in the above-described fashion completes the rubber track.

According to the separable rubber track, when a relatively weak rubber molding is damaged when the tank is traveling, only the damaged track unit 15 need be replaced, and replacement is simply conducted by unfastening the bolts 9 to maintain and repair the rubber track. Therefore, maintenance and repair of the rubber track of a tank is very convenient and expenses for the maintenance and repair of the tank are remarkably reduced.

Furthermore, the maintenance and repair of the rubber track of a tank is performed simply by unfastening the bolts 9 coupled with the coupling members 10 to replace the damaged track unit 15. Therefore, since the maintenance and repair of the rubber track of a tank can be performed where the tank is located, it is advantageous that the tank installed with the rubber track according to the preferred embodiment can exhibit excellent mobility.

It should be understood that the foregoing relates only to preferred embodiments of the present invention, and that the preferred embodiments are intended to cover all changes and modifications of the embodiments of the invention herein used for the purposes of the disclosure, which do not constitute departures from the spirit and scope of the invention.

According to the above-described present invention, a rubber track is divided into a plurality of track units such that, when a track unit is damaged when the tank is traveling, only the damaged track unit need be replaced. Therefore, compared with the conventional rubber track in which, when a part of the conventional rubber track is damaged, the entire rubber track must be replaced, according to the present invention, it is possible to conveniently maintain and repair the rubber track and to remarkably reduce expenses for the maintenance and repair of the rubber track.

Furthermore, in order to replace the damaged track unit, only the bolts coupled with the coupling members are unfastened to replace the damaged track unit. Therefore, it is possible to repair the rubber track where the tank is located without transporting the tank to a maintenance site to replace the entire rubber track unlike in the conventional art. As a result, time and effort spent on maintaining and repairing the rubber track can be remarkably reduced and the tank with the rubber track according to the present invention can exhibit excellent mobility.

1. A separable rubber track of a tank molded such that a plurality of steel cores engaged with a sprocket are integrated with each other by rubber, wherein the rubber track is divided into a plurality of track units, each track unit comprising:
a pair of connection cores connected to the steel cores and provided on both ends of the track unit; and
coupling members rotatably coupled with the connection cores such that the track units are connected to each other by coupling members to form an integrated endless track.

2. The separable rubber track of a tank as set forth in claim 1, wherein the connection cores includes a pair of connection pins provided on both sides of the leading ends thereof such that the coupling members are coupled with the connection cores by the connection pins to rotatably connect adjacent track units to each other.

3. The separable rubber track of a tank as set forth in claim 2, wherein the coupling members are divided into a top coupling member and a bottom coupling member, and the top coupling member and the bottom coupling member form connection grooves, into which the connection pins are rotatably inserted, on both ends of the surfaces that face each other in the coupling members divided into top and bottom coupling members such that the top and bottom coupling members of the coupling members are fastened to each other by fastening means.

4. The separable rubber track of a tank as set forth in claim 3, wherein the fastening means comprises, bolts penetrating the top and bottom coupling members of the coupling members, and nuts coupled with the bolts.
